(19) United States
(12) Patent Application Publication
(10) Pub. No.: US 2014/0020210 A1
(43) Pub. Date: Jan. 23, 2014

(54) HANDHELD TOOL ADD-ON HANDLE

(71) Applicants: Jens BRENNENSTUHL, Albershausen (DE); Juergen LUGINSLAND, Waldenbuch (DE); Thomas DAHLER, Filderstadt (DE); Marco BRAUN, Stuttgart-Feuerbach (DE); Andreas HEBER, Bissingen An Der Teck (DE)

(72) Inventors: Jens BRENNENSTUHL, Albershausen (DE); Juergen LUGINSLAND, Waldenbuch (DE); Thomas DAHLER, Filderstadt (DE); Marco BRAUN, Stuttgart-Feuerbach (DE); Andreas HEBER, Bissingen An Der Teck (DE)

(73) Assignee: ROBERT BOSCH GMBH, Stuttgart (DE)

(21) Appl. No.: 13/943,297

(22) Filed: Jul. 16, 2013

(30) Foreign Application Priority Data
Jul. 20, 2012 (DE) 10 2012 212 803.4

(51) Int. Cl. B25F 5/02; B25G 1/00

(52) U.S. Cl. CPC B25F 5/026; B25G 1/00
USPC 16/426

(57) ABSTRACT

A handheld tool add-on handle includes: a coupling arrangement provided to produce a detachable connection to a handheld tool; and at least two rotary form-locking elements provided to produce a coupling in the rotational direction. The coupling arrangement has at least one guiding form-locking element which is at least provided to produce a coupling in the axial direction, and which is situated between the rotary form-locking elements.

### BACKGROUND OF THE INVENTION

1. Field of the Invention

The present invention relates to a handheld tool add-on handle having coupling means that are provided to produce a detachable connection to an handheld tool and which has at least one or more rotary form-locking elements, which are provided to produce a coupling in the rotary direction.

2. Description of the Related Art

In Published German patent application document DE 10 2009 027 570 A1 a handheld tool add-on handle is described, having coupling means that are provided to produce a detachable connection to an handheld tool and which has at least one or more rotary form-locking elements, which are provided to produce a coupling in the rotary direction.

### BRIEF SUMMARY OF THE INVENTION

It is provided according to the present invention that the coupling means have at least one guiding form-locking element, which is at least provided to produce a coupling in the axial direction, and which is situated between the rotary form-locking elements. By “coupling means” one should particularly understand means which, in a coupled operating state, counteract a motion of a gripping means of the handheld tool add-on handle relative to the handheld tool. The coupling means advantageously bound an essentially cylindrical handheld tool accommodation region. The coupling means are preferably provided to enter a coupling to an essentially annular fastening range of the handheld tool. The fastening range of the handheld tool in a coupled operating state is particularly situated in the handheld tool accommodation region. The fastening range of the handheld tool preferably has form-locking means which are developed to be compatible with the form-locking means of the coupling means. By a “detachable connection” one should especially understand a connection which is developed to be able to be opened by a user nondestructively and/or advantageously without a tool.

By an handheld tool one should particularly understand a device for processing a workpiece, but preferably a drilling machine, a multifunctional tool, a saw, a plane, a milling machine, a grinder, an angle sander, a garden tool and/or particularly advantageously a hammer drill and/or impact hammer, a percussion drill and/or a screwdriver. By a “rotary form-locking element” one should particularly understand a form-locking element which is provided to produce at least one form-locking in the circumferential direction of the at least essentially cylindrical jacket shaped fastening range of the handheld tool and/or particularly in the circumferential direction of the handheld tool accommodation region. The rotary form-locking elements are preferably developed as connections in an attached form on a body of the coupling means. In particular, the rotary form-locking elements are developed in a raised manner relative to at least one outer surface of the body of the coupling means. In this case, form-locking elements of the handheld tool are preferably developed as recesses bounded by the fastening range of the handheld tool. Alternatively or in addition, the rotary form-locking elements could be developed as recesses bounded by the body of the coupling means. Then, form-locking elements of the handheld tool are preferably developed as raised connections in an attached form on an area of the fastening range of the handheld tool. “Provided” in particular means specially configured and/or equipped. The expression “produce a coupling in the rotary direction” in particular means that the rotary form-locking element, at least in a coupled operating state, counteracts a motion about a rotary axis of the handheld tool accommodation region relative to the handheld tool. By “guiding form-locking element” one should particularly understand means provided to produce form locking in the axial direction of the handheld tool accommodation region and/or especially in the axial direction of the at least essentially annular fastening range of the handheld tool. The expression “produce a coupling in the axial direction” in particular means that the guiding form-locking element, at least in the-coupled operating state, counteracts a motion in the axial direction of the handheld tool accommodation region relative to the handheld tool. By “situated between the rotary form-locking elements” one should understand, particularly in this connection, that the guiding form-locking element is situated on at least one straight line, which intersects the rotary form-locking elements on both sides of the guiding form-locking elements. An especially rigid coupling to the handheld tool is able to be achieved by the design, according to the present invention, of the handheld tool add-on handle. Furthermore, a change of a coupling position is especially advantageously possible because the guiding form-locking element guides the handheld tool add-on handle during the change on the handheld tool. In addition, an inexpensive production is possible.

In one additional embodiment, it is provided that the coupling means have two additional rotary form-locking elements, between which the guiding form-locking element is situated, whereby constructively simply an especially high rigidity of the coupling between the handheld tool add-on handle and the handheld tool may be achieved. The additional rotary form-locking elements are preferably situated at a distance from the current rotary form-locking elements.

It is also provided that the rotary form-locking elements are developed to be partially cylindrically shaped, whereby an advantageously low wear is able to be achieved while rotating the handheld tool add-on handle relative to the handheld tool. By “partially cylindrically shaped” one should understand that the rotary form-locking elements have a lateral surface, which forms at least a part of a lateral surface of a cylinder. The rotary form-locking element preferably has a partially circular cross section in at least one plane. Alternatively or in addition, rotary form-locking elements could have another shape, appearing meaningful to one skilled in the art, they could, for instance, have a trapezoidal cross section.

It is further provided that the guiding form-locking element projects above the rotary form-locking elements, whereby the handheld tool add-on handle is guided partially advantageously during a change in the coupling position. By the term “project above” one should particularly understand that the guiding form-locking element is developed in such a way that, during a coupling, it comes into engagement with the handheld tool before the rotary form-locking element. The guiding form-locking element preferably projects above the rotary form-locking elements in the radial direction of the handheld tool accommodation region. Alternatively, the guiding form-locking element could stand back behind the rotary form-locking elements. “Standing back” in this case means particularly that the rotary form-locking elements project above the guiding form-locking element.

Furthermore, it is provided that the rotary form-locking elements be situated at the end regions of the guiding form-locking element, whereby constructively simply an especially high rigidity of the coupling between the handheld tool add-on handle and the handheld tool may be achieved. The expression “situated at end regions” means that the rotary form-locking elements are situated less than 10 mm, advantageously less than 5 mm, from two points that are farthest apart from each other of the guiding form-locking element. In particular, a first and a second of the rotary form-locking elements are situated at a first of the end regions, and a third and a fourth of the rotary form-locking elements are situated at a second of the end regions. The rotary form-locking elements are preferably situated at a distance of less than 5 mm, advantageously less than 2 mm from the guiding form-locking element.

In addition, it is provided that the rotary form-locking elements are situated abutting the guiding form-locking element, whereby an especially simple production is made possible. “Situated abutting” means especially that the rotary form-locking elements and the guiding form-locking element lie against each other. Preferably, there is no gap between the rotary form-locking elements and the guiding form-locking element. Especially preferred, the rotary form-locking element and the guiding form-locking element are formed of a single workpiece, directly going over into each other.

Moreover, it is provided that the coupling means have at least two outer form-locking elements, between which the rotary form-locking elements are situated, whereby an especially rigid coupling with the handheld tool is able to be achieved. An “outer form-locking element means particularly a form-locking element which is situated along an outer edge of the essentially cylindrical handheld tool accommodation region. The outer form-locking element is advantageously provided to effect form locking at least in the radial direction of the handheld tool accommodation region. The coupling means advantageously have four outer form-locking elements. Alternatively, the coupling means might have only one outer form-locking element.

In one advantageous development of the present invention, it is provided that the coupling means be developed in one piece, whereby a particularly cost-effective production is made possible. By “developed as one piece” one should particularly understand in one continuous material, such as by a welding process and/or an adhesion process, etc., and particularly advantageously connected in an attached form, such as by production by casting and/or production in a monocomponent or particularly a multicomponent injection molding method.

Furthermore, it is provided that the handheld tool add-on handle includes a guide spring, which, in at least one operating state, squeezes the coupling means and the handle means axially apart, whereby the handheld tool add-on handle is guided particularly advantageously in case of a change in the coupling position.

Moreover, it is provided that the handheld tool add-on handle have a tensioning device that is provided to apply a force onto the handheld tool in the direction of at least the rotary form-locking elements, whereby in a constructively simple manner one is able to provide an advantageously detachable coupling. By a “tensioning device” one should understand particularly a device having a lever, a screw, a cam and/or another means meaningful to one skilled in the art, which, in at least one operating state counteracts a motion, and which counteracts the detaching of a form-locking connection of the rotary form-locking elements, of the guiding form-locking element and/or the outer form-locking elements. The tensioning device is preferably provided, in an operating state, to make possible a motion of the coupling means relative to the handheld tool, which detaches the form-locking connection to the handheld tool. In particular, one should understand by the phrase “applying a force in the direction of the rotary form-locking elements” in this instance, that the tensioning device presses the handheld tool at least against the rotary form-locking elements and advantageously against the guiding form-locking element and/or particularly the outer form-locking elements.

In addition, it is provided that the tensioning device suspends the guiding spring in at least one operating state, whereby a particularly high rigidity of the coupling is achieved between the handheld tool add-on handle and the handheld tool, and an advantageous guidance of the handheld tool add-on handle is made possible when there is a change in a coupling position. “Suspends” should particularly mean that the tensioning device effects a force which compresses the guiding spring all the way to form a stop.

Moreover, it is provided that the handheld tool add-on handle includes handle means provided to operate the tensioning device, whereby in a constructively simple manner a detachable coupling is made possible without the use of a tool. By “handle means” is meant particularly means that are provided to be grasped by an operator during a working process. By “operating” one should understand particularly that a motion of the handle means by the operator exerts a force on the handheld tool in the direction of the rotary form-locking elements.

### BRIEF DESCRIPTION OF THE DRAWINGS

FIG. 1 shows a system according to the present invention, having a handheld tool add-on handle and an handheld tool as in FIG. 1.

FIG. 2 shows the handheld tool add-on handle and a fastening range of the handheld tool of FIG. 1 in a sectional representation.

FIG. 3 shows a coupling means of the handheld tool add-on handle from FIG. 1 in a perspective representation.

FIG. 4 shows a fastening range of the handheld tool from FIG. 1 in a perspective representation.

FIG. 5 shows a handheld tool add-on handle and a fastening range of a handheld tool of an alternative exemplary embodiment in a sectional representation.

FIG. 6 shows a coupling means of the handheld tool add-on handle from FIG. 5 in a perspective representation.

FIG. 7 shows a fastening range of the handheld tool from FIG. 5 in a perspective representation.

### DETAILED DESCRIPTION OF THE INVENTION

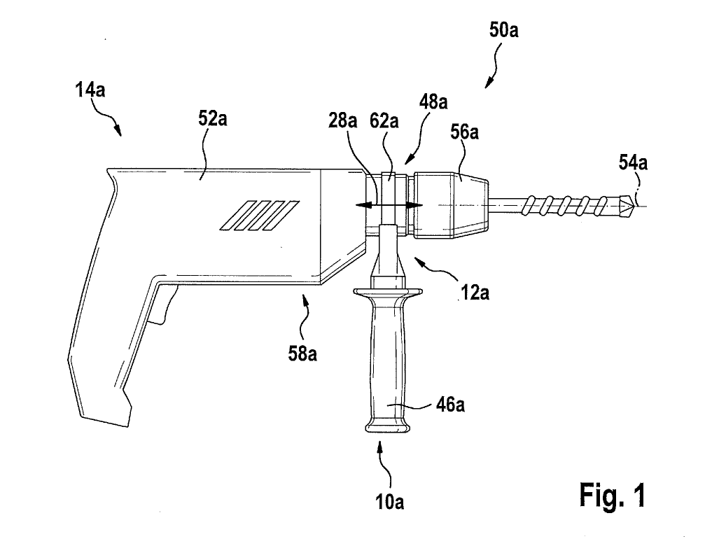

FIG. 1 shows a system 50a having a handheld tool add-on handle 10a, according to the present invention, and a handheld tool 14a. Hand-held tool 14a is developed as a percussion drilling screw machine. Handheld tool 14a has a pistol-shaped handheld tool housing 52a. Handheld tool housing 52a includes a fastening range 48a, which is torsionally fixed and coupled in the axial direction to handheld tool add-on handle 10a. Fastening range 48a is situated, in this context, in an handheld tool accommodation region 30a of handheld tool add-on handle 10a and bounded by handheld tool add-on handle 10a.

Fastening range 48a encloses a rotational axis 54a of an insert tool fastener 56a of handheld tool 14a. Fastening range 48a is situated between insert tool fastener 56a and a housing region 58a of handheld tool housing 52a, which encloses its drive unit of handheld tool 14a, that is not shown in greater detail Handheld tool add-on handle 10a is able to be coupled in a plurality of positions, round about rotational axis 54a of insert tool fastener 56a, to fastening range 48 of handheld tool 14a.

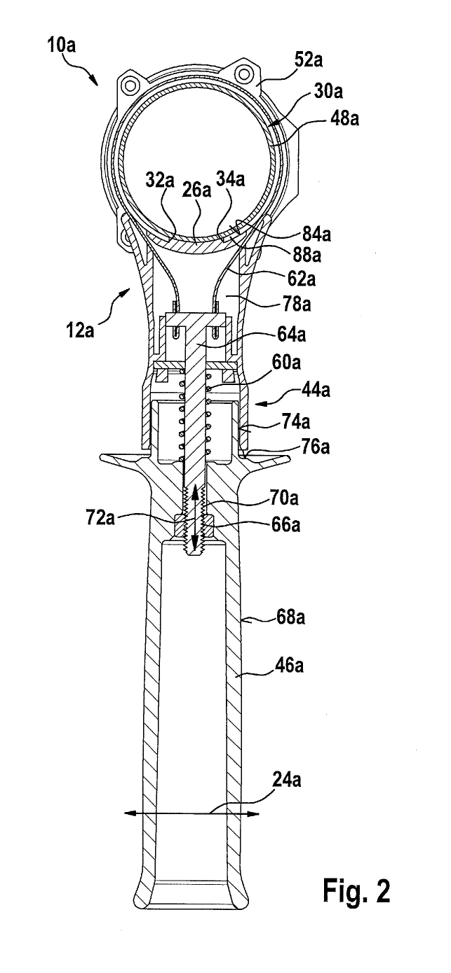

FIG. 2 shows handheld tool add-on handle 10a and a part of handheld tool housing 52a, which has fastening range 48a. Handheld tool add-on handle 10a includes a coupling means 12a, a tensioning device 44a, an handle means 48a and a guiding spring 60a. Tensioning device 44a, in a coupled operating state shown, gives rise to a force onto handheld tool 14a which draws handheld tool 14a in the direction of coupling means 12a.

Tensioning device 44a has a fastening means 62a and a tensioning means 64a. Fastening means 62a encloses handheld tool accommodation region 30a. Consequently, fastening means 62a, in the coupled operating state, encloses fastening range 48a of handheld tool 14a. In the coupled operating state, fastening means 62a gives rise to the force directly onto fastening range 48a of handheld tool 14a. Fastening means 62a is developed as a band.

Fastening means 62a is formed of a material that does not appear meaningful to one skilled in the art. In this case, fastening means 62a is formed of a metal. Tensioning means 64a is developed as a tensioning screw. Tensioning means 64a is axially displaceable and is supported torsionally fixed coupling means 12a. Tensioning means 64a is connected to fastening means 62a. A motion of tensioning means 64a directed away from fastening range 48a tensions fastening means 62a about fastening range 48a of handheld tool 14a.

Handle 48a has a thread 66a which is connected torsionally fixed to an handle surface 68a of handle 46a. Thread 66a engages with a thread 70a of tensioning means 84a. By a rotation of handle means 46a, tensioning means 64a is moved in the axial direction 72a onto fastening range 48a of handheld tool 14a towards or away from fastening range 48 a of handheld tool 14a. Thereby a coupling of coupling means 12a to fastening range 48a of handheld tool 14a is able to be established and detached.

Handle means 46a has a support surface 74a which, in an uncoupled operating state, supports coupling means 12a movably in the axial direction 72a. Handle means 46a has a stop surface 76a against which coupling means 12a lies in the coupled operating state. In the coupled operating state, tensioning device 44a presses coupling means 12a against stop surface 76a of handle means 46a. Guiding spring 60a is situated effectively between coupling means 12a and handle means 46a. Guiding spring 60a presses coupling means 12a and handle means 46a apart from each other in axial direction 72. During a detachment of tensioning device 44a, guiding spring 60a first presses coupling means 12a against fastening range 48a of handheld tool 14a. If tensioning device 44a has been detached sufficiently far, the coupling of coupling means 12a to fastening range 48a may be completely detached by pulling back coupling means 12a against a force of guiding spring 60a.

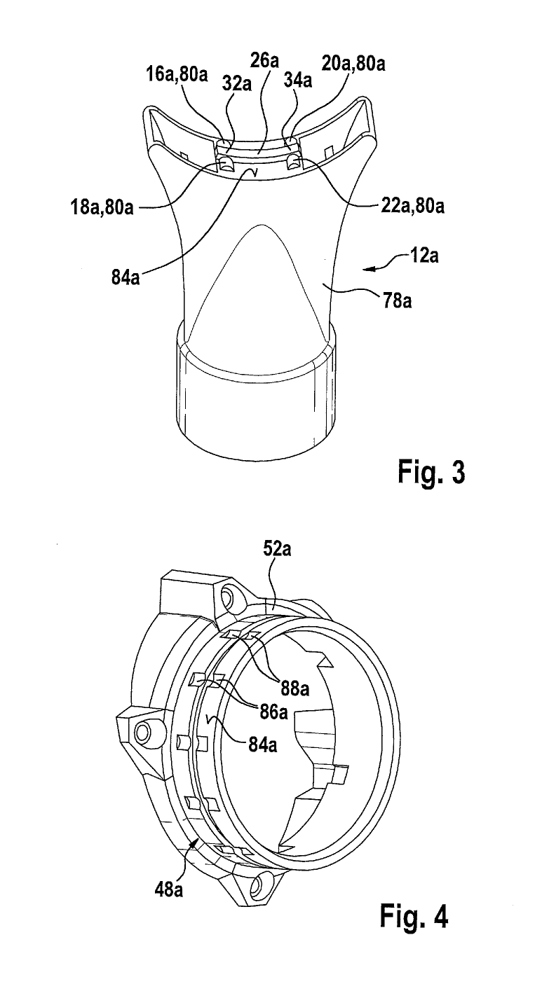

Coupling means 12a shown in greater detail in FIG. 3 is provided to produce a detachable connection to fastening range 48a of handheld tool 14a. For this purpose, coupling means 12a has four rotary form-locking elements 16a, 18a, 20a, 22a, a guiding form-locking element 26a and a body 78a. Rotary form-locking elements 16a-22a are provided for producing a coupling in rotary direction 24a. For this purpose, rotary form-locking elements 16a-22a are developed to be partially cylindrically shaped. They protrude beyond an outer surface 84a of body 78a of coupling means 12a that faces fastening range 48a of handheld tool 14a. Lateral faces 80a of rotary form-locking elements 16a-22a are aligned in parallel to an axis about which handheld tool add-on handle 10a is rotatable about fastening range 48a of handheld tool 14a.

Guiding form-locking element 26a is provided for producing a coupling in the axial direction 28a. Guiding form-locking element 26a is developed as a crosspiece, whose main direction of extension is aligned in the circumferential direction about the axis, about which handheld tool add-on handle 10a is rotatable about fastening range 48a of handheld tool 14a. Guiding form-locking element 26a projects beyond outer surface 84a of body 78a of coupling means 12a, which faces fastening range 48a of handheld tool 14a. Guiding form-locking element 26a also projects farther beyond outer surface 84a of body 78a of coupling means 12a than rotary form-locking element 16a-22a of coupling means 12a. Consequently, guiding form-locking element 26a projects beyond rotary form-locking elements 16a-22a.

Two of the rotary form-locking elements 16a-22a are each situated at an end region 32a, 34a of guiding form-locking element 26a. In this context, guiding form-locking element 26a is situated between the respectively two rotary form-locking elements 16a-22a. Rotary form-locking elements 16a-22a are situated abutting guiding form-locking element 26a. Rotary form-locking elements 16a-22a, guiding form-locking element 26a and body 78a of coupling means 12a are developed in one piece. Coupling means 12a is produced using an injection molding procedure.

FIG. 4 shows the part of handheld tool housing 52a and a part of handheld tool housing 52a, which has fastening range 48a. Fastening range 48a has a cylinder sleeve-shaped base shape. Fastening range 48a has first form-locking elements 86a, which are provided to produce a coupling in rotational direction 24a. A part of first form-locking elements 86a, in the coupled operating state, forms a form locking with rotary form-locking elements 16a-22a. First form-locking elements 86a are developed as recesses in the cylinder sleeve-shaped base shape of fastening range 48a. First form-locking elements 86a are developed as partially cylindrically shaped recesses. First form-locking elements 86a are situated regularly about the axis about which handheld tool add-on handle 10a is rotatable about fastening range 48a of handheld tool 14a. In different alignments of handheld tool add-on handle 10a relative to handheld tool 14a, rotary form-locking elements 16a-22a engage with different first form-locking elements 86a. Fastening range 48a has twelve first form-locking elements 86a.

Fastening range 48a has first form-locking elements 88a, which are provided to produce a coupling in rotational direction 28a. In the coupled operating state, second form-locking element 88a forms a form locking with guiding form-locking element 26a. Second form-locking element 88a is developed as recess in the cylinder sleeve-shaped base shape of fastening range 48a. Second form-locking element 88a is developed as a groove. Second form-locking element 88a encloses the axis about which handheld tool add-on handle 10a is rotatable about fastening range 48a of handheld tool 14a. Second form-locking element 88a is situated respectively between two first form-locking elements 86a, which are situated in the same angular range of the axis.

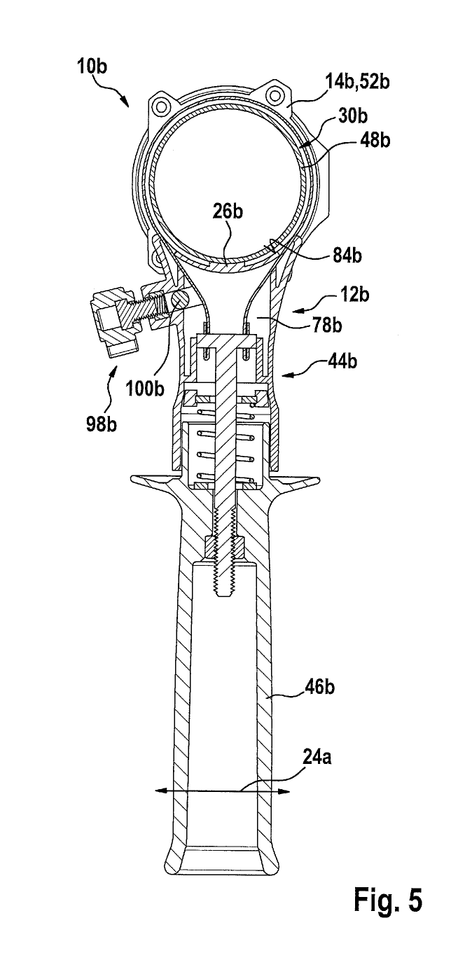

An exemplary embodiment of the present invention is represented in FIGS. 5 through 7. The following description and the drawings are essentially limited to the differences between the exemplary embodiments. Regarding components designated in the same way, particularly regarding components bearing identical reference numerals, it is basically possible to refer also to the drawings and/or the description of the other exemplary embodiment, especially of FIGS. 1 through 4. In order to distinguish the exemplary embodiments, the letter a has been added after the reference numerals of the exemplary embodiment in FIGS. 1 through 4. In the exemplary embodiments of FIGS. 5 through 7, the letter a was replaced by the letter b.

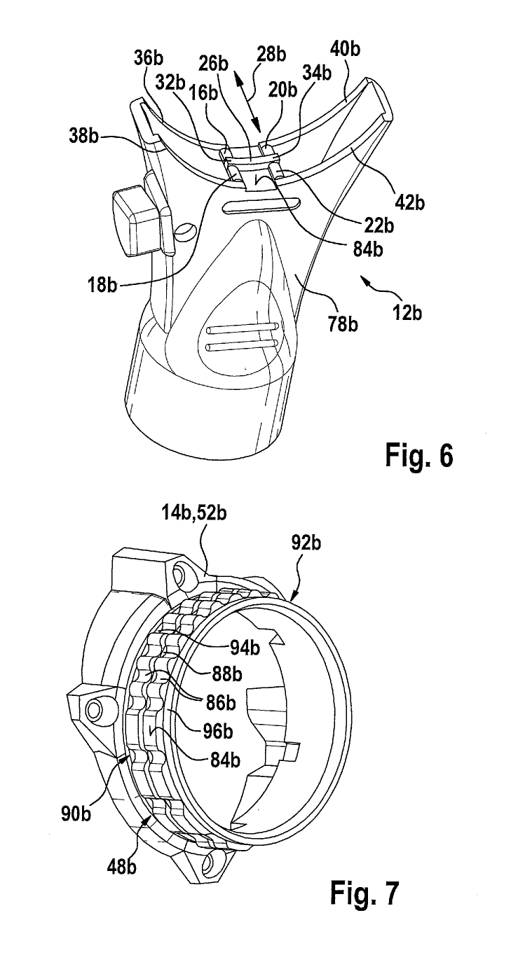

FIG. 5 shows an handheld tool add-on handle 10b and a part of an handheld tool housing 52b of an handheld tool add-on handle 14b. The part of handheld tool housing 52b includes a fastening range 48b. Handheld tool add-on handle 10b includes a cylinder-shaped handheld tool accommodation region 30b, in which fastening range 48b of handheld tool 14b is situated in a coupled operating state. As is shown in FIG. 6, handheld tool add-on handle 10b has a coupling means 12b having four rotary form-locking elements 16b, 18b, 20b, 22b, a guiding form-locking element 26b, four outer form-locking elements 36b, 38b, 40b, 42b and a body 78b. Rotary form-locking elements 16b-22b are provided for producing a coupling to fastening range 48b of handheld tool 14b in rotational direction 24b. Guiding form-locking element 26b is provided for producing a coupling to fastening range 48b of handheld tool 14b in axial direction 28b. Guiding form-locking element 26b is situated between rotary form-locking elements 16b-22b.

Rotary form-locking elements 16b-22b are situated in each case between two of outer form-locking elements 36b-42b. Outer form-locking elements 36b-42b are developed as ribs. Outer form-locking elements 36b-42b project beyond an outer surface 84b, of body 78b of coupling means 12b, that faces handheld tool according to the present invention 30b. Outer form-locking elements 36b-42b, in a coupled operating state, run along edges of the essentially cylindrical sleeve-shaped fastening range 48b of handheld tool 14b. Outer form-locking elements 36b-42b run by about 45 degrees about an axis, by which handheld tool add-on handle 10b is rotatable about fastening range 48b of handheld tool 14b. Outer form-locking elements 36b-42b are each situated in a plane which is aligned perpendicular to this axis.

Outer form-locking elements 38b-42b project less far beyond outer surface 84b of body 78b of coupling means 12 than guiding form-locking element 28b. Furthermore, outer form-locking elements 38b-42b project less far beyond outer surface 84b of body 78b of coupling means 12 than rotary form-locking elements 16b-22b.

FIG. 7 shows the part of handheld tool housing 52b, which has fastening range 48b of handheld tool 14b. Fastening range 48b includes first form-locking elements 88b, which are provided to produce a coupling in rotational direction 24b. Some of first form-locking elements 86b, in the coupled operating state, form a form locking with rotary form-locking elements 16b-22b. First form-locking elements 86b are developed as wave-shaped situated recesses in the cylinder sleeve-shaped base shape of fastening range 48b. First form-locking elements 86b are situated essentially regularly about the axis about which handheld tool add-on handle 10b is rotatable about fastening range 48b of handheld tool 14b.

Rotary form-locking elements 16b-22b of handheld tool add-on handle 10b, at various alignments of handheld tool add-on handle 10b relative to handheld tool 14, engage with different first form-locking elements 86b. In an angular range 90b, in which rotary form-locking elements 16b-22b engage if handheld tool add-on handle 10b is essentially aligned parallel to a main handle of handheld tool 14b, coupling means 12b has fewer first form-locking elements 86b than in another angular range 92b. Because of that, a setting in which handheld tool add-on handle 10b is not aligned parallel to a main handle of handheld tool 14b, is particularly convenient to set.

Fastening range 48b has second form-locking elements 88b, which is provided to produce a coupling in axial direction 28b. In the coupled operating state, second form-locking element 88b forms a form locking with guiding form-locking element 26b. Second form-locking element 88b is developed as a recess in the cylinder sleeve-shaped base shape of fastening range 48b. Second form-locking element 88b is developed as a groove. Second form-locking element 88b encloses the axis about which handheld tool add-on handle 10a is rotatable about fastening range 48b of handheld tool 14b. Second form-locking element 88b is situated between respectively two first form-locking elements 86b, which are situated in the same angular range of the axis, that is, which are situated one behind the other in the axial direction.

Fastening range 48b has two third form-locking elements 94b, 96b, which are provided to produce a coupling in axial direction 28b. Third form-locking elements 94b, 96b, in the coupled operating state, form a form locking with outer form-locking elements 36b-42b. Starting from the cylinder sleeve-shaped base form, first form-locking elements 86b project less far into the part of handheld tool housing 52b than second form-locking element 88b. Starting from the cylinder sleeve-shaped base form, third form-locking element 94b projects less far into the part of handheld tool housing 52b than second form-locking element 88b. Furthermore, starting from the cylinder sleeve-shaped base form, third form-locking element 94b projects less far into the part of handheld tool housing 52b than second form-locking element 88b. It is possible for one skilled in the art to mix up form-locking elements which are developed as recesses and form-locking elements fitting these, which are developed as connections in an attached form.

Handheld tool add-on handle 10b has a fastening mechanism 98b, which is provided to fasten a spacer rod 100b, which in turn is provided to limit the penetration of an insert tool into a workpiece.

What is claimed is:

1. A handheld tool add-on handle, comprising:
a coupling arrangement provided to produce a detachable connection to a handheld tool; and
at least two rotary form-locking elements provided on the coupling arrangement to produce a coupling in the rotational direction;
wherein the coupling arrangement has at least one guiding form-locking element which is (i) provided to produce at least a coupling in the axial direction, and (ii) situated between the rotary form-locking elements.

2. The handheld tool add-on handle as recited in claim 1, wherein the coupling arrangement has two additional rotary form-locking elements, and wherein the guiding form-locking element is situated between the two additional rotary form-locking elements.

3. The handheld tool add-on handle as recited in claim 2, wherein the rotary form-locking elements are configured to be at least partially cylindrical-shaped.

4. The handheld tool add-on handle as recited in claim 2, wherein the guiding form-locking element projects beyond the rotary form-locking elements.

5. The handheld tool add-on handle as recited in claim 4, wherein the rotary form-locking elements are situated at end regions of the guiding form-locking element.

6. The handheld tool add-on handle as recited in claim 4, wherein the rotary form-locking elements are situated abutting the guiding form-locking element.

7. The handheld tool add-on handle as recited in claim 4, wherein the coupling arrangement has at least two outer form-locking elements, and wherein the rotary form-locking elements are situated between the two outer form-locking elements.

8. The handheld tool add-on handle as recited in claim 7, wherein the coupling arrangement is configured as one piece.

9. The handheld tool add-on handle as recited in claim 4, further comprising:
a handle arrangement; and
a guiding spring which is configured to, in at least one operating state, separate the coupling arrangement and the handle arrangement axially apart.

10. The handheld tool add-on handle as recited in claim 9, further comprising:
a stressing device configured to apply a force onto the handheld tool in a direction of at least the rotary form-locking elements.

11. The handheld tool add-on handle as recited in claim 10, wherein the stressing device suspends the guiding spring in at least one operating state.

12. The handheld tool add-on handle as recited in claim 10, wherein the handle arrangement is configured to operate the stressing device.

13. The handheld tool add-on handle as recited in claim 10, wherein the handheld tool has a fastening range, and wherein the handheld tool add-on handle is configured to be coupled to the fastening range.
